(19) United States
(12) Patent Application Publication
(10) Pub. No.: US 2024/0057165 A1
(43) Pub. Date: Feb. 15, 2024

(54) CHANNEL SENSING DURING AWAY PERIOD

(71) Applicant: QUALCOMM Incorporated, San Diego, CA (US)

(72) Inventors: Siyi CHEN, Beijing (CN); Arumugam CHENDAMARAI KANNAN, San Diego, CA (US); Giovanni CHISCI, San Diego, CA (US); Jing SUN, San Diego, CA (US); Vinay CHANDE, San Diego, CA (US); Xiaoxia ZHANG, San Diego, CA (US); Changlong XU, Beijing (CN)

(21) Appl. No.: 18/547,635

(22) PCT Filed: Apr. 30, 2021
(86) PCT No.: PCT/CN21/91446

§ 371 Date: Aug. 23, 2023

(51) Int. Cl. H04W 74/08

(52) U.S. Cl. CPC H04W 74/0816

(57) ABSTRACT

Various aspects of the present disclosure generally relate to wireless communication. In some aspects, a wireless communication device may start, in a no-listen-before-talk (no-LBT) mode and after a first channel occupancy time (COT), an away period during which no transmissions are to occur in abeam direction used in the first COT. The wireless communication device may perform, during the away period, channel sensing. The wireless communication device may transmit a communication in a second COT after the away period, based at least in part on a result of the channel sensing. Numerous other aspects are described.

### FIELD OF THE DISCLOSURE

Aspects of the present disclosure generally relate to wireless communication and to techniques and apparatuses for channel sensing during an away period in a no-listen-before-talk mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink’ or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a wireless communication device includes starting, in a no-listen-before-talk (no-LBT) mode and after a first channel occupancy time (COT), an away period during which no transmissions are to occur in a beam direction used in the first COT. The method may include performing, during the away period, channel sensing, and transmitting a communication in a second COT after the away period, based at least in part on a result of the channel sensing.

In some aspects, a method of wireless communication performed by a base station includes generating, for a UE operating in a no-LBT mode, an indication of a duration of a restriction period that follows an away period during which no transmissions are to occur by the UE in a beam direction used in the first COT and during which the UE performs channel sensing, where the away period follows a channel occupancy time, and transmitting the indication to the UE.

In some aspects, a wireless communication device for wireless communication includes a memory and one or more processors, coupled to the memory, configured to start, in a no-LBT mode and after a first COT, an away period during which no transmissions are to occur in a beam direction used in the first COT. The one or more processors may be configured to perform, during the away period, channel sensing, and transmit a communication in a second COT after the away period, based at least in part on a result of the channel sensing.

In some aspects, a base station for wireless communication includes a memory and one or more processors, coupled to the memory, configured to generate, for a UE operating in a no-LBT mode, an indication of a duration of a restriction period that follows an away period during which no transmissions are to occur by the UE in a beam direction used in the first COT and during which the UE performs channel sensing, where the away period follows a channel occupancy time, and transmit the indication to the UE.

In some aspects, a non-transitory computer-readable medium storing a set of instructions for wireless communication includes one or more instructions that, when executed by one or more processors of a wireless communication device, cause the wireless communication device to start, in a no-LBT mode and after a first COT, an away period during which no transmissions are to occur in a beam direction used in the first COT, perform, during the away period, channel sensing, and transmit a communication in a second COT after the away period, based at least in part on a result of the channel sensing.

In some aspects, a non-transitory computer-readable medium storing a set of instructions for wireless communication includes one or more instructions that, when executed by one or more processors of a base station, cause the base station to generate, for a UE operating in a no-LBT mode, an indication of a duration of a restriction period that follows an away period during which no transmissions are to occur by the UE in a beam direction used in the first COT and during which the UE performs channel sensing, where the away period follows a channel occupancy time, and transmit the indication to the UE.

In some aspects, an apparatus for wireless communication includes means for starting, in a no-LBT mode and after a first COT, an away period during which no transmissions are to occur in a beam direction used in the first COT, means for performing, during the away period, channel sensing, and means for transmitting a communication in a second COT after the away period, based at least in part on a result of the channel sensing.

In some aspects, an apparatus for wireless communication includes means for generating, for a UE operating in a no-LBT mode, an indication of a duration of a restriction period that follows an away period during which no transmissions are to occur by the UE in a beam direction used in the first COT and during which the UE performs channel sensing, where the away period follows a channel occupancy time, and means for transmitting the indication to the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antenna, radio frequency chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of an away period, in accordance with the present disclosure.

FIG. 4 is a diagram illustrating an example of channel sensing during an away period, in accordance with the present disclosure.

FIG. 5 is a diagram illustrating an example of using a restriction period, in accordance with the present disclosure.

FIG. 6 is a diagram illustrating an example of using away periods per beam, in accordance with the present disclosure.

FIG. 7 is a diagram illustrating an example process performed, for example, by a wireless communication device, in accordance with the present disclosure.

FIG. 8 is a diagram illustrating an example process performed, for example, by a base station, in accordance with the present disclosure.

FIGS. 9-10 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

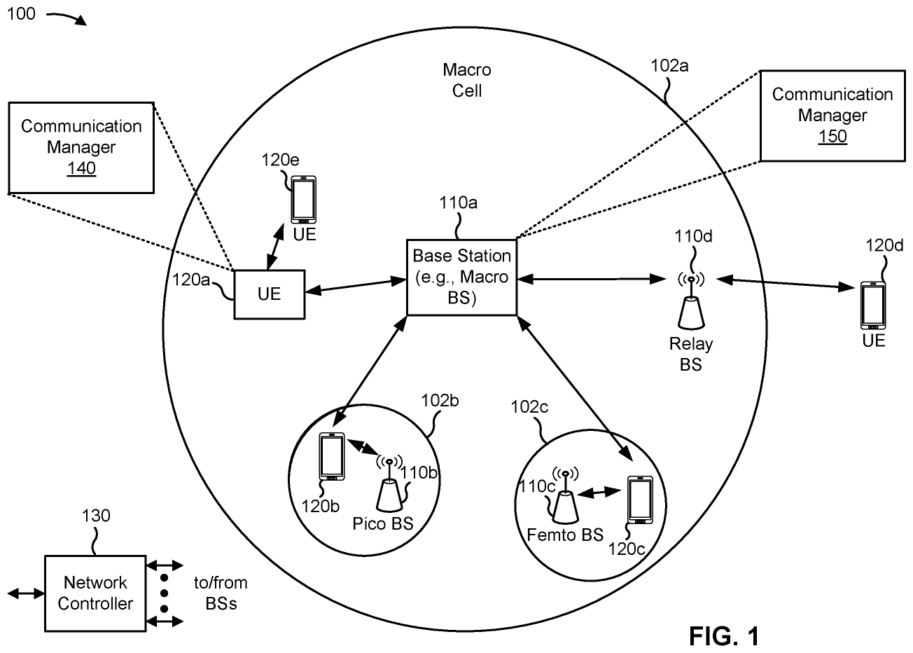

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the wireless communication device may include a communication manager 140 or communication manager 150. As described in more detail elsewhere herein, the communication manager 140 or the communication manager 150 may start, in a no-listen-before-talk (no-LBT) mode and after a first channel occupancy time (COT), an away period during which no transmissions are to occur in a beam direction used in the first COT. The communication manager 140 or the communication manager 150 may perform, during the away period, channel sensing, and transmit a communication in a second COT after the away period, based at least in part on a result of the channel sensing. Additionally, or alternatively, the communication manager 140 or the communication manager 150 may perform one or more other operations described herein.

In some aspects, the base station 110 may include a communication manager 150. As described in more detail elsewhere herein, the communication manager 150 may generate, for a UE operating in a no-LBT mode, an indication of a duration of a restriction period that follows an away period during which no transmissions are to occur by the UE in a beam direction used in the first COT and during which the UE performs channel sensing, where the away period follows a channel occupancy time, and transmit the indication to the UE. Additionally, or alternatively, the communication manager 150 may perform one or more other operations described herein.

As indicated above, FIG. 1 is provided as an example. Other examples may differ from what is described with regard to FIG. 1.

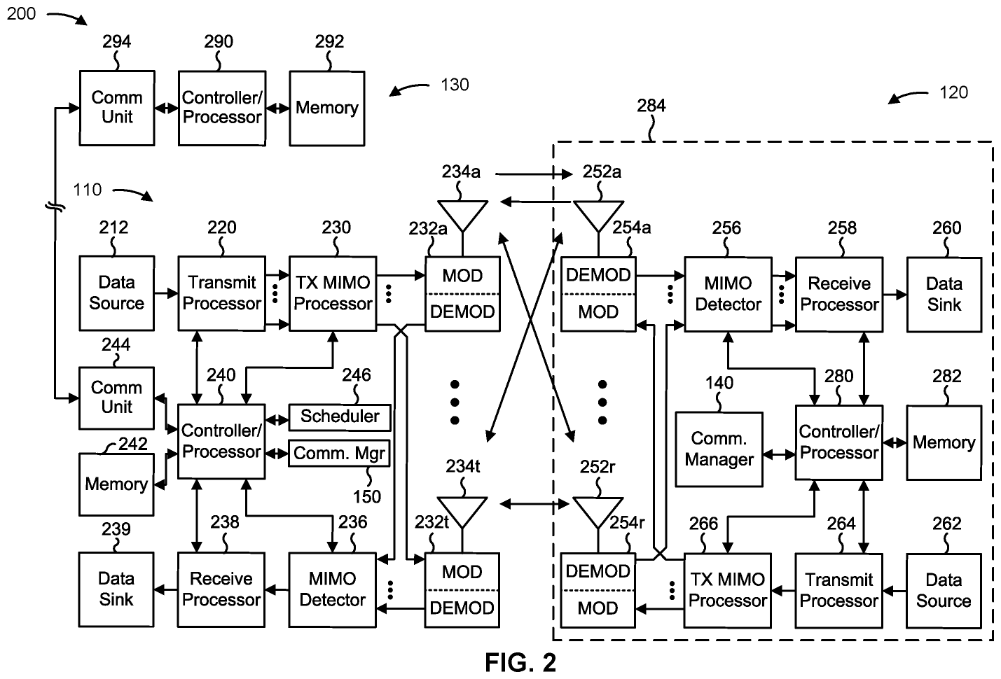

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 1-10).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 1-10).

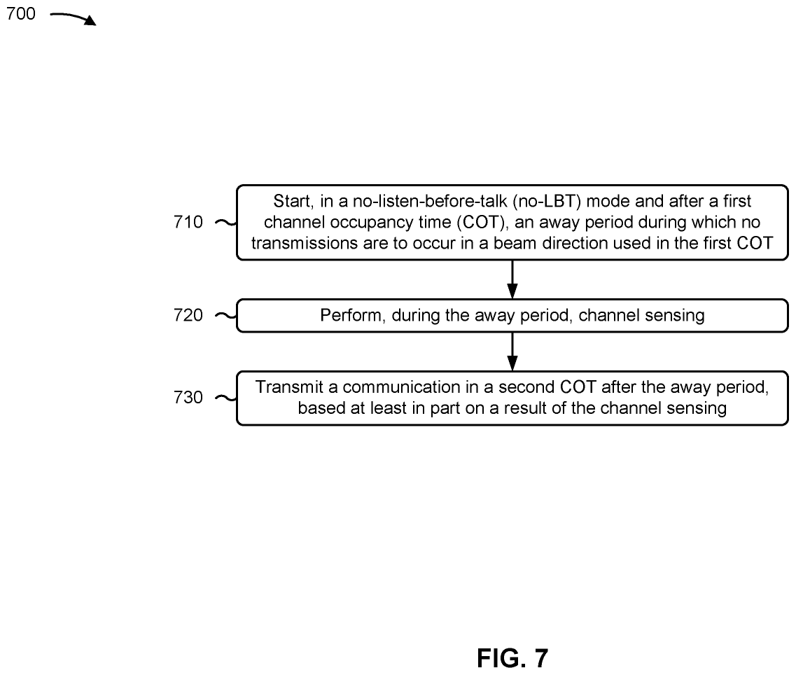

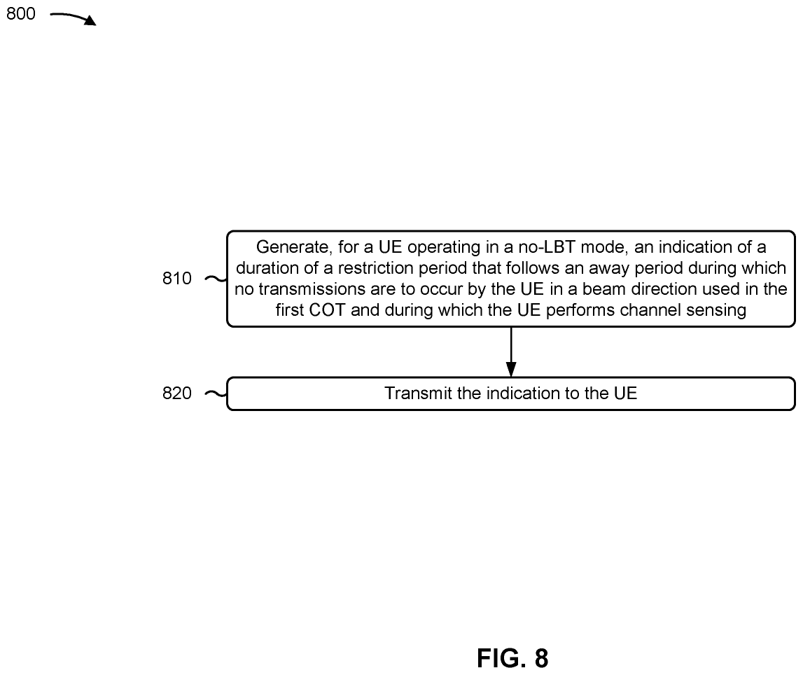

Controller/processor 240 of base station 110, controller/processor 280 of UE 120, a controller/processor of another wireless communication device, and/or any other component(s) of FIG. 2 may perform one or more techniques associated with channel sensing during an away period in a no-LBT mode, as described in more detail elsewhere herein. In some aspects, the wireless communication device described herein is the base station 110, is included in the base station 110, or includes one or more components of the base station 110 shown in FIG. 2. In some aspects, the wireless communication device described herein is the UE 120, is included in the UE 120, or includes one or more components of the UE 120 shown in FIG. 2. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include miming the instructions, converting the instructions, compiling the instructions, and/or interpreting the instructions, among other examples.

In some aspects, the wireless communication device (e.g., the base station 110, the UE 120) includes means for starting, in a no-LBT mode and after a first COT, an away period during which no transmissions are to occur in a beam direction used in the first COT, means for performing, during the away period, channel sensing, and/or means for transmitting a communication in a second COT after the away period, based at least in part on a result of the channel sensing. In some aspects, the means for the wireless communication device to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246. In some aspects, the means for the wireless communication device to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for generating, for a UE operating in a no-LBT mode, an indication of a duration of a restriction period that follows an away period during which no transmissions are to occur by the UE in a beam direction used in the first COT and during which the UE performs channel sensing, wherein the away period follows a channel occupancy time, and/or means for transmitting the indication to the UE. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

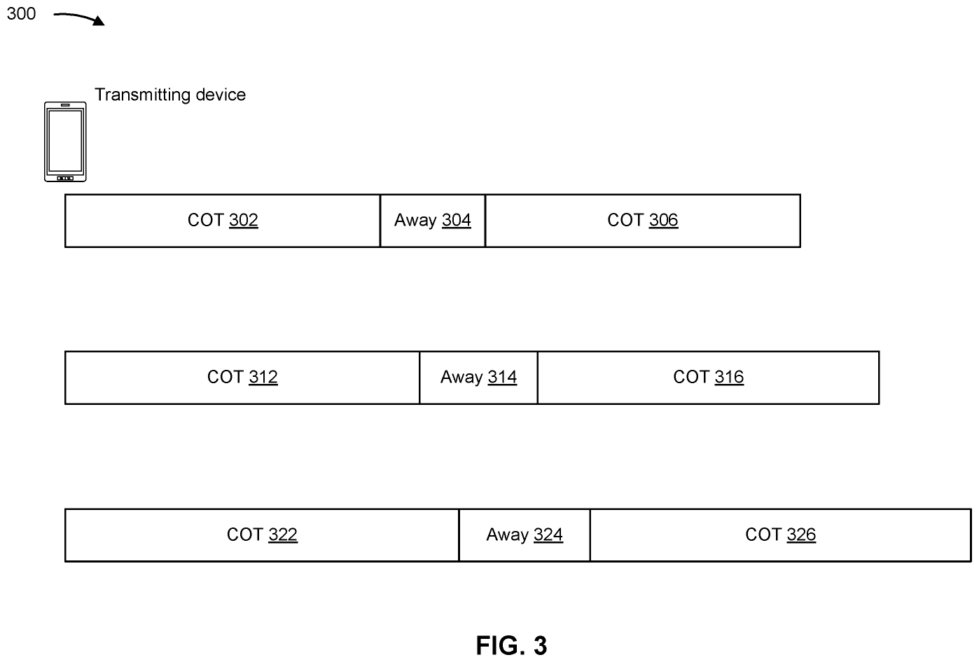

FIG. 3 is a diagram illustrating an example 300 of an away period, in accordance with the present disclosure.

In a shared or unlicensed frequency band, a transmitting device may contend against other devices for channel access before transmitting on a shared or unlicensed channel to reduce and/or prevent collisions on the shared or unlicensed channel. To contend for channel access, the transmitting device may perform a channel access procedure, such as an LBT procedure, for shared or unlicensed frequency band channel access. The channel access procedure may be performed to determine whether the physical channel (e.g., the radio resources of the channel) is free to use or is busy (e.g., in use by another wireless communication device such as a UE, an IoT device, or a WLAN device, among other examples). The channel access procedure may include sensing or measuring the physical channel (e.g., performing an RSRP measurement, detecting an energy level, or performing another type of measurement) during a channel access gap (which may also be referred to as a contention window) and determining whether the shared or unlicensed channel is free or busy based at least in part on the signals sensed or measured on the physical channel (e.g., based at least in part on whether the measurement satisfies a threshold). If the transmitting device determines that the channel procedure was successful, the transmitting device may perform one or more transmissions on the shared or unlicensed channel during a transmission opportunity, which may extend for a COT.

A transmitting device may operate in an LBT mode, where an LBT system specifies that LBT is to be performed before transmission. In some scenarios, the transmitting device may operate in a no-LBT mode, where a no-LBT system specifies that LBT does not need to be performed before transmission. In a no-LBT system, where there are no sensing requirements, it may be difficult for a transmitting device to identify a situation in which the transmitting device is constantly accessing the channel to the detriment of other transmitting devices. In order to allow transmitting devices of a no-LBT system to coexist with transmitting devices of an LBT system, each transmitting device of the no-LBT system may employ an “away-time” operation in which the transmitting device that has occupied the channel does not occupy the channel for an “away period.” After the away period, the transmitting device may access the channel.

Example 300 shows a first COT 302 that is followed by an away period 304 during which the transmitting device does not transmit in a beam direction that was used in the first COT 302. After the away period 304 ends, the transmitting device may transmit in a second COT 306. In some scenarios, the away period may be a function of a length of the COT, and the away period may increase over time. For example, COT 312, away period 314, and COT 316 may be longer in duration than COT 302, away period 304, and COT 306. COT 322, away period 324, and COT 326 may be longer in duration than COT 312, away period 314, and COT 316. By using an away period, the transmitting device is able to avoid being locked in a mode in which transmitting devices of an LBT system are not able to transmit. Furthermore, the away period helps neighboring systems to maintain a peak data rate.

At high transmission frequencies, such as 60 GHz, a wireless communication system may operate in an LBT mode (e.g., C1) that requires LBT by the transmitting device or operate in a no-LBT mode (e.g., C2) that does not require LBT by the transmitting device. Although LBT may not be mandated, LBT may still be beneficial. If an LBT system is deployed together with a no-LBT system, the LBT system may suffer degraded performance, because only the LBT system may back off of transmission while the no-LBT system does not. This may dissuade a network operator to use an LBT mode. By using an away period, a no-LBT system may allow for long gaps between transmission so that the LBT system can pass an LBT procedure and start a transmission. However, if the no-LBT system does not perform any channel sensing during the away period, the no-LBT system may perform transmission during a next COT, which may not protect the LBT system. If the LBT system and the no-LBT system cannot successfully coexist, some transmitting devices may not be able to transmit.

As indicated above, FIG. 3 is provided as an example. Other examples may differ from what is described with regard to FIG. 3.

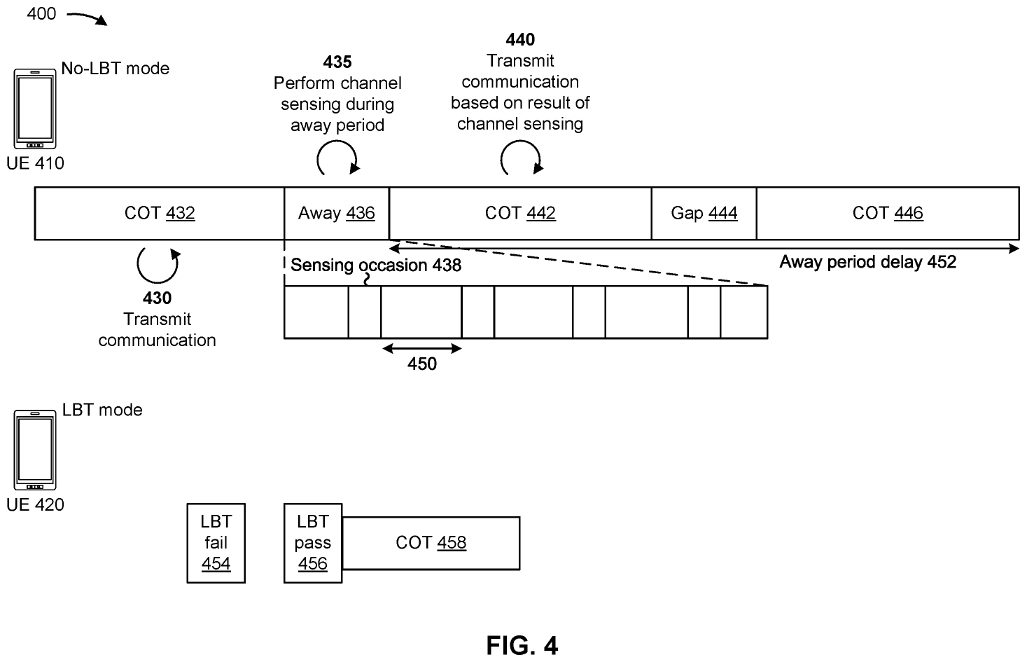

FIG. 4 is a diagram illustrating an example 400 of channel sensing during an away period, in accordance with the present disclosure. As shown in FIG. 4, UE 410 (e.g., UE 120) is a transmitting device operating in a no-LBT mode and UE 420 (e.g., UE 120) is a transmitting device operating in an LBT mode. UE 410 and UE 420 may communicate with BS 110 and/or other wireless communication devices in a wireless network (e.g., wireless network 100). UE 410 and UE 420 may be transmitting devices of neighboring or coexisting systems.

According to various aspects described herein, a transmitting device of a no-LBT system may perform channel sensing on a channel during an away period in order to determine if a transmitting device in a coexisting LBT system is transmitting. The transmitting device of the no-LBT system may wait to transmit if a result of the channel sensing is that the channel is not clear. The transmitting device of the no-LBT system may also enter a restriction period after the away period to limit a transmit power or a duty cycle of transmissions during the restriction period. In this way, the transmitting device of the no-LBT system may reduce interference for the transmitting device of the LBT system.

As show by reference number 430, a wireless communication device, such as UE 410, may transmit one or more communications to another wireless communication device on a sidelink or to a base station on an access link. UE 410 may transmit the one or more communications during a first COT 432.

While UE 410 is operating in a no-LBT mode, as shown by reference number 435, UE 410 may perform channel sensing during an away period 436 that follows COT 432. The channel sensing may be for a beam (beam direction) that is to be used for a next COT. A duration of the away period 436 may satisfy a threshold duration (e.g., minimum duration, maximum duration, duration indicated by a base station). For example, the minimum duration of the away period 436 may be as long as or longer in duration than an LBT procedure or an enhanced clear channel assessment (eCCA). In some aspects, UE 410 may perform channel sensing at multiple occasions 438 during the away period 436. Each of the multiple occasions 438 may be performed for a threshold duration (e.g., minimum duration, maximum duration, specified quantity of microseconds) and/or at a consistent duration. UE 410 may determine that a result of the channel sensing is clear if a specified quantity N out of a total quantity K of the sensing occasions are clear. For a loose configuration, the quantity N may be as few as 1. For a tighter configuration, the quantity N may be equal to K.

As shown by reference number 440, UE 410 may transmit a communication during a second COT 442 based at least in part on a result of the channel sensing. If the result of the channel sensing is clear, UE 410 may transmit a communication. If the result of the channel sensing is not clear, UE 410 may not transmit a communication or may transmit with restrictions.

In some aspects, there may be a gap 444 between COTs that is not an away period. For example, the gap 444 is shown between COT 442 and another COT 446. During the gap, UE 410 may not perform channel sensing or take action to add energy to the channel. The gap 444 may be left free by UE 410 for UE 420 or other wireless communication devices that operate in an LBT mode. After COT 446, there may be another away period.

In some aspects, there may be other durations that are enforced. For example, during the away period 436, the sensing occasions 438 may be separated by a threshold duration 450, such as a minimum duration, a maximum duration, a consistent duration, or a specified quantity of microseconds. There may also be a limit on away periods or a limit on a length of time (e.g., specified quantity of milliseconds) for away periods. For example, after the away period 436, there may be an away period delay 452 before another away period. The away period delay 452 may be subject to a threshold duration for delaying the away period. This threshold duration may be a minimum duration between away periods (so that the gap between away periods is not too short) or a maximum duration between away periods (so that the gap between away periods is not too long). The away period delay 452 may be specified as a frequency of away periods or a maximum duration of transmissions (channel occupancies) without an away period. The away period 436 may have started based at least in part on an earlier away period delay.

In some aspects, the duration of the away period 436 may be extended or shortened by being multiplied by a factor Kᵢ. Kᵢ may be a function of an ith time that a consecutive away period is used (without reverting to a contention-free time). UE 410 may use a smaller Kᵢ to shorten the duration of the away period 436 and a larger Kᵢ to lengthen the duration.

While UE 410 performs the one or more communications during COT 432, UE 420 may perform an LBT procedure, and as shown by reference number 454, the LBT procedure may fail. However, once UE 410 enters the away period, UE 420 may perform a successful LBT procedure, as shown by reference number 456. UE 420 may then transmit communications during COT 458. When UE 410 performs channel sensing during the away period 436, UE 410 may detect energy in the channel (caused by UE 420's transmissions during COT 458). If the channel is clear during the away period 436, UE 410 may start transmissions during the COT 442. However, as a result of the channel not being clear during the away period 436, UE 410 may, for example, extend the away period 436 before starting COT 442 or enter a restriction period.

As indicated above, FIG. 4 is provided as an example. Other examples may differ from what is described with respect to FIG. 4.

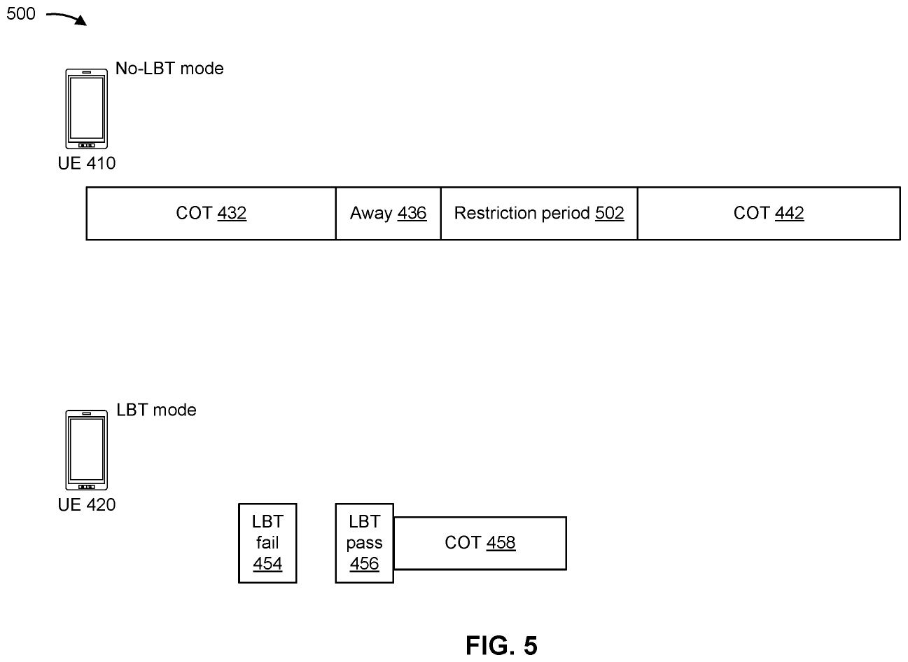

FIG. 5 is a diagram illustrating an example 500 of using a restriction period, in accordance with the present disclosure.

Example 500 shows that UE 410 may enter a restriction period 502 if a result of the channel sensing during the away period 436 is that the channel is not clear. The restriction period 502 may be a period, after the away period 436, during which UE 410 operates with some type of restriction on transmission. For example, UE 410 may reduce a transmit power and/or a duty cycle (e.g., a percentage of time for transmission) during the restriction period 502. The duty cycle may include, in addition to a transmission time, a silence time, which may be an away period with channel sensing or a period where transmission has ceased. In some aspects, UE 410 may switch to an LBT mode during the restriction period 502. After the restriction period 502, UE 410 may revert to a previous mode of operation. For example, if LBT successes while in the LBT mode satisfies a minimum success threshold (e.g., percentage successful, ratio of success, quantity of successful occasions), UE 410 may revert back to the no-LBT mode. Once the restriction period 502 ends, UE 410 may transmit as normal during COT 442.

In some aspects, a base station may indicate a duration of the restriction period 502 or the duration may be based at least in part on stored configuration information (set by a communication standard). The restriction period 502 may be longer in duration than a maximum COT that is specified in configuration information. The duration may be transmitter-specific and may be reconfigured during a transmission.

In some aspects, the restriction period 502 may be extended or shortened based at least in part on an indication from the base station, stored configuration information, an energy detection value, and/or a result of the channel sensing. For example, the duration may be based at least in part on an energy detection value. If the energy detection value satisfies an energy threshold (e.g., minimum signal strength), the restriction period 502 may be extended in length. Higher energy detection values may correspond to a longer duration.

The duration may be based at least in part on the result of the channel sensing. If no channel sensing occasions are clear, the restriction period 502 may be extended. If some channel sensing occasions are clear, the restriction period 502 may be shortened. That is, the duration of the restriction period 502 may be a function of a quantity of channel assessments of channel clearance. A smaller quantity of clear results may correspond to a longer duration. In some aspects, the away period 436, before the restriction period 502, may be extended or shortened.

By sensing the channel during the away period, UE 410 may restrict future transmissions so as to provide for a successful LBT procedure by UE 420. As a result, the LBT system and the non-LBT system may coexist so as to reduce interference, latency, and/or blockage of transmissions by the LBT system.

As indicated above, FIG. 5 is provided as an example. Other examples may differ from what is described with regard to FIG. 5.

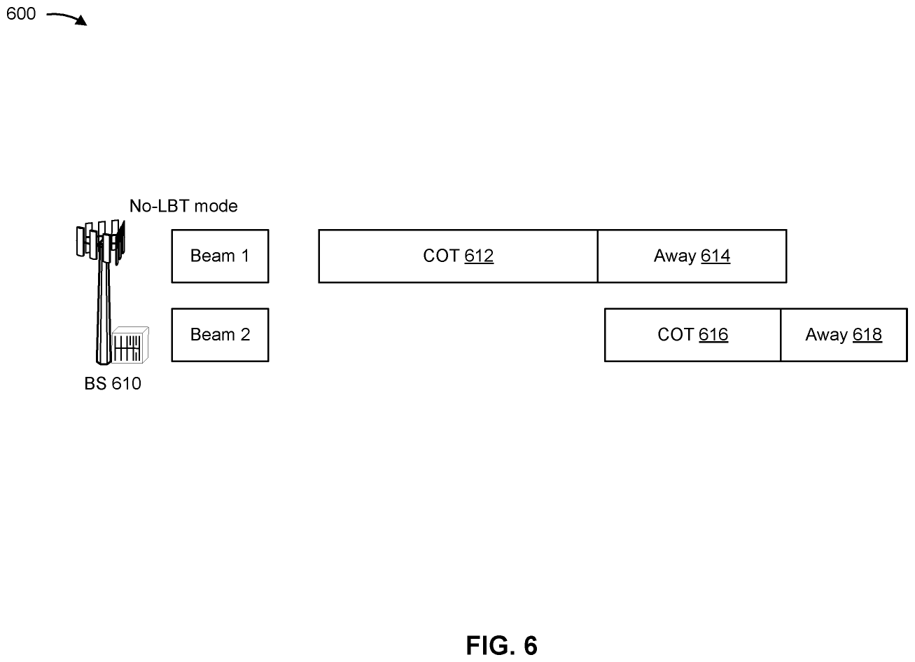

FIG. 6 is a diagram illustrating an example 600 of using away periods per beam, in accordance with the present disclosure. Example 600 shows a transmitting device, such as BS 610 (e.g., BS 110), that may use away periods while in a no-LBT mode.

COT periods and away periods of different beams or sets of beams may take place at different times and/or with different durations. Example 600 shows a COT 612 that is followed by an away period 614 for a first beam (Beam 1) and a COT 616 that is followed by an away period 618 for a second beam (Beam 2). COT 612 is longer than COT 616, but takes place during away period 614. If BS 610 is not transmitting on Beam 1, BS 610 may still transmit on Beam 2. If Beam 1 has entered away period 614 and performing channel sensing, BS 610 may refrain from transmitting during that time. Away period 618 may be later than away period 614 and may be shorter than away period 614. Other configurations may be specified for individual beams or beam sets. In this way, a transmitting device may have more flexibility in determining how to coexist with an LBT system.

As indicated above, FIG. 6 is provided as an example. Other examples may differ from what is described with regard to FIG. 6.

FIG. 7 is a diagram illustrating an example process 700 performed, for example, by a wireless communication device, in accordance with the present disclosure. Example process 700 is an example where the wireless communication device (e.g., UE 410, BS 110, BS 610) performs operations associated with channel sensing during an away period in a no-LBT mode. In a first aspect, the wireless communication device is a user equipment. In a second aspect, alone or in combination with the first aspect, the wireless communication device is a base station.

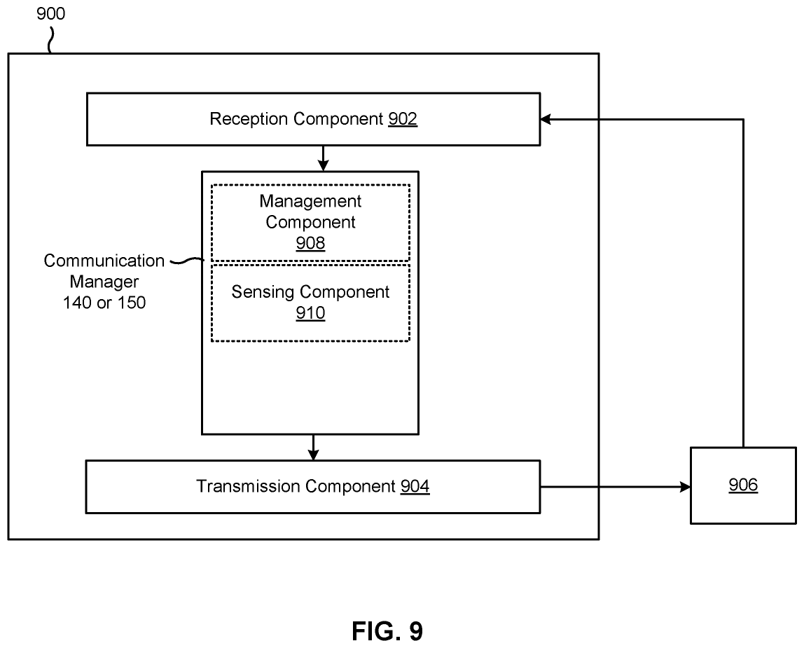

As shown in FIG. 7, in some aspects, process 700 may include starting, in a no-LBT mode and after a first COT, an away period during which no transmissions are to occur in a beam direction used in the first COT (block 710). For example, the wireless communication device (e.g., using communication manager 140, communication manager 150, and/or management component 908 depicted in FIG. 9) may start, in a no-LBT mode and after a first COT, an away period during which no transmissions are to occur in a beam direction used in the first COT, as described above in connection with FIGS. 3-6.

As further shown in FIG. 7, in some aspects, process 700 may include performing, during the away period, channel sensing (block 720). For example, the wireless communication device (e.g., using communication manager 140, communication manager 150, and/or sensing component 910 depicted in FIG. 9) may perform, during the away period, channel sensing, as described above in connection with FIGS. 3-6. In a third aspect, alone or in combination with one or more of the first and second aspects, the away period is longer in duration than a maximum eCCA period that could be configured for the wireless communication device. In a fourth aspect, alone or in combination with one or more of the first through third aspects, the away period is started after a threshold duration for delaying the away period.

As further shown in FIG. 7, in some aspects, process 700 may include transmitting a communication in a second COT after the away period, based at least in part on a result of the channel sensing (block 730). For example, the wireless communication device (e.g., using communication manager 140, communication manager 150, and/or transmission component 904 depicted in FIG. 9) may transmit a communication in a second COT after the away period, based at least in part on a result of the channel sensing, as described above in connection with FIGS. 3-6.

Process 700 may include additional aspects, such as any single aspect or any combination of aspects described below and/or in connection with one or more other processes described elsewhere herein.

In a fifth aspect, alone or in combination with one or more of the first through fourth aspects, the channel sensing is performed with a beam that is expected to be used for the second COT.

In a sixth aspect, alone or in combination with one or more of the first through fifth aspects, the channel sensing is performed for a threshold duration.

In a seventh aspect, alone or in combination with one or more of the first through sixth aspects, the channel sensing is performed at multiple occasions throughout the away period. In an eighth aspect, alone or in combination with one or more of the first through seventh aspects, the multiple occasions are separated by at least a threshold duration. In a ninth aspect, alone or in combination with one or more of the first through eighth aspects, the result of the channel sensing is clear if a threshold quantity of the multiple occasions are clear.

In a tenth aspect, alone or in combination with one or more of the first through ninth aspects, process 700 includes starting the second COT after a restriction period if the result of the channel sensing is not clear, where the restriction period starts after an end of the away period. In an eleventh aspect, alone or in combination with one or more of the first through tenth aspects, a duration of the restriction period is based at least in part on one or more of stored configuration information, an energy detection value, or the result of the channel sensing.

In a twelfth aspect, alone or in combination with one or more of the first through eleventh aspects, process 700 includes, during the restriction period, switching to an LBT mode based at least in part on the result of the channel sensing.

In a thirteenth aspect, alone or in combination with one or more of the first through twelfth aspects, process 700 includes, during the restriction period, reducing a transmit power. In a fourteenth aspect, alone or in combination with one or more of the first through thirteenth aspects, process 700 includes, during the restriction period, reducing a duty cycle.

In a fifteenth aspect, alone or in combination with one or more of the first through fourteenth aspects, process 700 includes extending the away period before starting the restriction period.

In a sixteenth aspect, alone or in combination with one or more of the first through fifteenth aspects, the away period and the channel sensing are applied per beam or set of beams.

In a seventeenth aspect, alone or in combination with one or more of the first through sixteenth aspects, process 700 includes receiving an indication of a duration for the restriction period.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with channel sensing during an away period in a no-LBT mode.

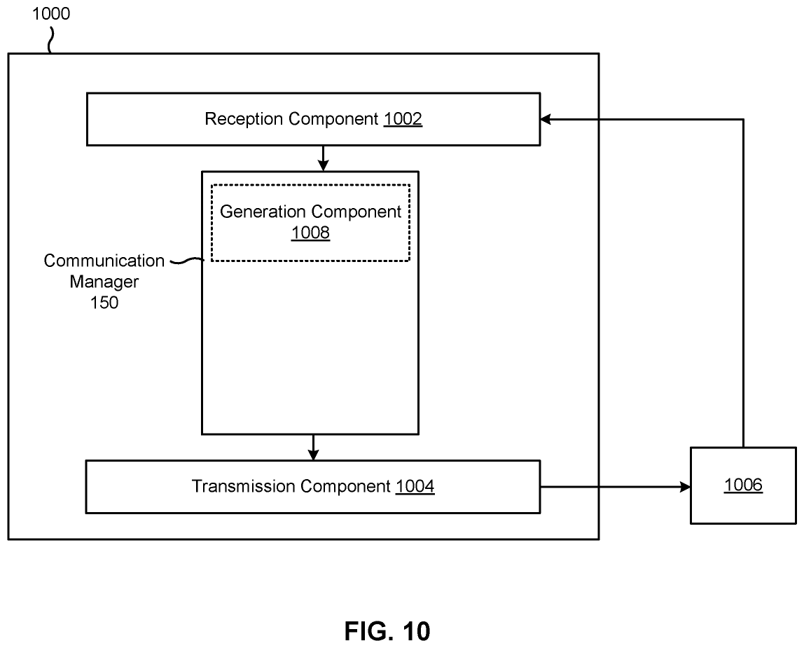

As shown in FIG. 8, in some aspects, process 800 may include generating, for a UE operating in a no-LBT mode, an indication of a duration of a restriction period that follows an away period during which no transmissions are to occur by the UE in a beam direction used in the first COT and during which the UE performs channel sensing (block 810). For example, the base station (e.g., using communication manager 150 and/or generation component 1008 depicted in FIG. 10) may generate, for a UE operating in a no-LBT mode, an indication of a duration of a restriction period that follows an away period during which no transmissions are to occur by the UE in a beam direction used in the first COT and during which the UE performs channel sensing, as described above in connection with FIGS. 3-6. In some aspects, the away period follows a COT.

As further shown in FIG. 8, in some aspects, process 800 may include transmitting the indication to the UE (block 820). For example, the base station (e.g., using communication manager 150 and/or transmission component 1004 depicted in FIG. 10) may transmit the indication to the UE, as described above in connection with FIGS. 3-6.

Process 800 may include additional aspects, such as any single aspect or any combination of aspects described below and/or in connection with one or more other processes described elsewhere herein. In a first aspect, process 800 includes transmitting configuration information for the restriction period or the away period.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a wireless communication device (e.g., BS 110, BS 610, UE 120, UE 410), or a wireless communication device may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140 or the communication manager 150. The communication manager 140 or the communication manager 150 may include a management component 908 and/or a sensing component 910, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the wireless communication device described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the wireless communication device described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the wireless communication device described above in connection with FIG. 2. In some aspects, the transmission component 904 may be co-located with the reception component 902 in a transceiver.

The management component 908 may start, in a no-LBT mode and after a first COT, an away period during which no transmissions are to occur in a beam direction used in the first COT. The sensing component 910 may perform, during the away period, channel sensing. The transmission component 904 may transmit a communication in a second COT after the away period, based at least in part on a result of the channel sensing.

The management component 908 may start the second COT after a restriction period if the result of the channel sensing is not clear, where the restriction period starts after an end of the away period. The management component 908 may extend the away period before starting the restriction period. The reception component 902 may receive an indication of a duration for the restriction period.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a generation component 1008, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the base station described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the base station described above in connection with FIG. 2. In some aspects, the transmission component 1004 may be co-located with the reception component 1002 in a transceiver.

The generation component 1008 may generate, for a UE operating in a no-LBT mode, an indication of a duration of a restriction period that follows an away period during which no transmissions are to occur by the UE in a beam direction used in the first COT and during which the UE performs channel sensing, where the away period follows a channel occupancy time. The transmission component 1004 may transmit the indication to the UE. The transmission component 1004 may transmit configuration information for the away period.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The foregoing disclosure provides illustration and description, but is not intended to be exhaustive or to limit the aspects to the precise forms disclosed. Modifications and variations may be made in light of the above disclosure or may be acquired from practice of the aspects.

The following provides an overview of some Aspects of the present disclosure:

Aspect 1: A method of wireless communication performed by a wireless communication device, comprising: starting, in a no-listen-before-talk (no-LBT) mode and after a first channel occupancy time (COT), an away period during which no transmissions are to occur in a beam direction used in the first COT; performing, during the away period, channel sensing; and transmitting a communication in a second COT after the away period, based at least in part on a result of the channel sensing.

Aspect 2: The method of Aspect 1, wherein the wireless communication device is a user equipment.

Aspect 3: The method of Aspect 1, wherein the wireless communication device is a base station.

Aspect 4: The method of any of Aspects 1-3, wherein the away period is longer in duration than a maximum extended clear channel assessment period that could be configured for the wireless communication device.

Aspect 5: The method of any of Aspects 1-4, wherein the away period is started after a threshold duration for delaying the away period.

Aspect 6: The method of any of Aspects 1-5, wherein the channel sensing is performed with a beam that is expected to be used for the second COT.

Aspect 7: The method of any of Aspects 1-6, wherein the channel sensing is performed for a threshold duration.

Aspect 8: The method of any of Aspects 1-7, wherein the channel sensing is performed at multiple occasions throughout the away period.

Aspect 9: The method of Aspect 8, wherein the multiple occasions are separated by at least a threshold duration.

Aspect 10: The method of Aspect 9, wherein the result of the channel sensing is clear if a threshold quantity of the multiple occasions are clear.

Aspect 11: The method of any of Aspects 1-9, further comprising starting the second COT after a restriction period if the result of the channel sensing is not clear, wherein the restriction period starts after an end of the away period.

Aspect 12: The method of Aspect 11, wherein a duration of the restriction period is based at least in part on one or more of stored configuration information, an energy detection value, or the result of the channel sensing.

Aspect 13: The method of Aspect 11 or 12, further comprising, during the restriction period, switching to an LBT mode based at least in part on the result of the channel sensing.

Aspect 14: The method of any of Aspects 11-13, further comprising, during the restriction period, reducing a transmit power.

Aspect 15: The method of any of Aspects 11-14, further comprising, during the restriction period, reducing a duty cycle.

Aspect 16: The method of any of Aspects 11-15, further comprising extending the away period before starting the restriction period.

Aspect 17: The method of any of Aspects 11-16, further comprising receiving an indication of a duration for the restriction period.

Aspect 18: The method of any of Aspects 1-17, wherein the away period and the channel sensing are applied per beam or set of beams.

Aspect 19: A method of wireless communication performed by a base station, comprising: generating, for a user equipment (UE) operating in a no listen-before-talk (no-LBT) mode, an indication of a duration of a restriction period that follows an away period during which no transmissions are to occur by the UE in a beam direction used in the first COT and during which the UE performs channel sensing, wherein the away period follows a channel occupancy time; and transmitting the indication to the UE.

Aspect 20: The method of Aspect 19, further comprising transmitting configuration information for the restriction period or the away period.

Aspect 21: An apparatus for wireless communication at a device, comprising a processor; memory coupled with the processor; and instructions stored in the memory and executable by the processor to cause the apparatus to perform the method of one or more Aspects of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a memory; and
one or more processors, coupled to the memory, configured to:
start, in a no-listen-before-talk (no-LBT) mode and after a first channel occupancy time (COT), an away period during which no transmissions are to occur in a beam direction used in the first COT;
perform, during the away period, channel sensing; and
transmit a communication in a second COT after the away period, based at least in part on a result of the channel sensing.

2. The wireless communication device of claim 1, wherein the wireless communication device is a user equipment.

3. The wireless communication device of claim 1, wherein the wireless communication device is a base station.

4. The wireless communication device of claim 1, wherein the away period is longer in duration than a maximum extended clear channel assessment period that could be configured for the wireless communication device.

5. The wireless communication device of claim 1, wherein the away period is started after a threshold duration for delaying the away period.

6. The wireless communication device of claim 1, wherein the one or more processors are configured to perform channel sensing with a beam that is expected to be used for the second COT.

7. The wireless communication device of claim 1, wherein the one or more processors are configured to perform channel sensing for a threshold duration.

8. The wireless communication device of claim 1, wherein the one or more processors are configured to perform channel sensing at multiple occasions throughout the away period.

9. The wireless communication device of claim 8, wherein the multiple occasions are separated by at least a threshold duration.

10. The wireless communication device of claim 9, wherein the result of the channel sensing is clear if a threshold quantity of the multiple occasions are clear.

11. The wireless communication device of claim 1, wherein the one or more processors are configured to start the second COT after a restriction period if the result of the channel sensing is not clear, wherein the restriction period starts after an end of the away period.

12. The wireless communication device of claim 11, wherein a duration of the restriction period is based at least in part on one or more of stored configuration information, an energy detection value, or the result of the channel sensing.

13. The wireless communication device of claim 11, wherein the one or more processors are configured to, during the restriction period, switch to an LBT mode based at least in part on the result of the channel sensing.

14. The wireless communication device of claim 11, wherein the one or more processors are configured to, during the restriction period, reduce a transmit power.

15. The wireless communication device of claim 11, wherein the one or more processors are further configured to, during the restriction period, reduce a duty cycle.

16. The wireless communication device of claim 11, wherein the one or more processors are configured to extend the away period before starting the restriction period.

17. The wireless communication device of claim 11, wherein the one or more processors are configured to receive an indication of a duration for the restriction period.

18. The wireless communication device of claim 1, wherein the away period and the channel sensing are applied per beam or set of beams.

19. A base station for wireless communication, comprising:
a memory; and
one or more processors, coupled to the memory, configured to:
generate, for a user equipment (UE) operating in a no listen-before-talk (no-LBT) mode, an indication of a duration of a restriction period that follows an away period during which no transmissions are to occur by the UE in a beam direction used in the first COT and during which the UE performs channel sensing, wherein the away period follows a channel occupancy time; and
transmit the indication to the UE.

20. The base station of claim 19, wherein the one or more processors are configured to transmit configuration information for the restriction period or the away period.

21. A method of wireless communication performed by a wireless communication device, comprising:
starting, in a no-listen-before-talk (no-LBT) mode and after a first channel occupancy time (COT), an away period during which no transmissions are to occur in a beam direction used in the first COT;
performing, during the away period, channel sensing; and
transmitting a communication in a second COT after the away period, based at least in part on a result of the channel sensing.

22. The method of claim 21, wherein the wireless communication device is a user equipment.

23. The method of claim 21, wherein the wireless communication device is a base station.

24. The method of claim 21, wherein the away period is longer in duration than a maximum extended clear channel assessment period that could be configured for the wireless communication device.

25. The method of claim 21, wherein the away period is started after a threshold duration for delaying the away period.

26. The method of claim 21, wherein the channel sensing is performed at multiple occasions throughout the away period.

27. The method of claim 21, further comprising starting the second COT after a restriction period if the result of the channel sensing is not clear, wherein the restriction period starts after an end of the away period.

28. The method of claim 27, wherein a duration of the restriction period is based at least in part on one or more of stored configuration information, an energy detection value, or the result of the channel sensing.

29. The method of claim 27, further comprising, during the restriction period, reducing a transmit power or a duty cycle.

30. A method of wireless communication performed by a base station, comprising:
generating, for a user equipment (UE) operating in a no listen-before-talk (no-LBT) mode, an indication of a duration of a restriction period that follows an away period during which no transmissions are to occur by the UE in a beam direction used in the first COT and during which the UE performs channel sensing, wherein the away period follows a channel occupancy time; and
transmitting the indication to the UE.
